(19) United States
(12) Patent Application Publication
(10) Pub. No.: US 2026/0163676 A1
(43) Pub. Date: Jun. 11, 2026

(54) IMPROVEMENTS TO VIDEO DATA DISTRIBUTION NETWORKS

(71) Applicant: Global Invacom Ltd, Stevenage Hertfordshire (GB)

(72) Inventors: Steven Fisher, Stevenage Hertfordshire (GB); Matthew Robinson, Stevenage Hertfordshire (GB)

(73) Assignee: Global Invacom Ltd, Stevenage Hertfordshire (GB)

(21) Appl. No.: 18/707,468

(22) PCT Filed: Nov. 3, 2022
(86) PCT No.: PCT/GB2022/052774

§ 371 Date: May 3, 2024

(30) Foreign Application Priority Data
Nov. 4, 2021 (GB) 2115866.2

(51) Int. Cl. H04L 1/00; H04N 21/236; H04N 21/25; H04N 21/63

(52) U.S. Cl. CPC H04L 1/0076; H04L 1/0017; H04N 21/23614; H04N 21/25; H04N 21/631

(57) ABSTRACT

The application relates to apparatus and a method of providing streams of video data signals to a plurality of access points connected to a distribution network and at each of which there is the capability to connect at least one device so as to allow said video data to be processed to create a video display, said apparatus and method allowing the said video data signals to be sent to a plurality of connected access points and generating and sending forward error correction (FEC) data to accompany said video data signals to each of the access points to enhance the quality of the video service from the user devices connected to the access points and the format and/or amount of FEC data transmitted to said access points is defined and configured independently with respect to each of said access points.

The invention to which this application relates is to the provision of apparatus and a method which allows for the generation and usage of networks to which a number of devices can be simultaneously connected and to allow the network to be adapted and developed in order to allow reconfiguration of the same in order to meet changes in requirements and/or growth in the capacity and/or operation of the network over time.

The applicant, in their application number EP3520326, discloses a Software Defined Network (SDN). However a problem with known systems is that the requirements of devices and user locations can vary from location to location so that the settings and configuration which may be appropriate for one location in the network may not provide the best results at one or more further locations connected to the same network and in which case the users at the said further locations may not receive the optimum service.

An aim of the present invention is to allow the network to be operable in a manner which allows greater flexibility and adaptability of the operation of the same to meet and to allow the operating parameters of the network to react to real time operating conditions whilst maintaining the quality of service to all of the devices connected to the network above an acceptable threshold of operation.

The further aim of the present invention is to provide improvements to the SDN distribution system which allows the distribution of the video data to respective user locations to be optimised.

In accordance with a first aspect of the invention there is provided An SDN data distribution network including apparatus for the receipt of video data signals from one or more remote sources, means for transmission of the received data signals to a plurality of access points on said SDN network and means for generating and sending forward error correction (FEC) data to enhance the quality of the video service from user devices connected to said access points and wherein the format and/or amount of FEC data transmitted is configured with reference to a specific access point and with respect to the FEC data determined to be required by the user device connected to said access point.

In one embodiment the configuration of FEC data is determined independently for each of said access points

Typically at least one device at each of the access points transmits data that includes error information to a database which indicates a quality of video service at each of the access points at that instance of time.

Typically the error information which is received is processed and one or more indicators are generated to represent the quality of service at the devices at the respective Access Points and, in response to that analysis the type and/or quantity of the FEC data transmitted to each of the access points is controlled.

In one embodiment the control may be to retain the FEC data signals sent to each of the access points at the same level; to change the FEC data signals which are sent to all of the Access Points and/or to selectively change the FEC data signals which are sent to different Access Points.

In one embodiment any changes of the FEC data signals which are transmitted are performed in real time so as to allow any necessary changes to be made as soon as practical after the logging data which is received indicates that change is necessary for one or more of the Access Points.

Thus, in accordance with the invention the available bandwidth for the transmission of the FEC data signals can be more effectively used and managed in order to ensure that differences in the level of FEC data signals which are required between different Access Points can be taken into account and the appropriate level of FEC data signals is transmitted to the respective Access Points.

In one embodiment there is therefore provided a scalable amount of FEC in the network according to the amount of FEC needed to recover the video for one or more devices at a specific Access Point.

Typically there is provided a base layer of data transmission which comprises the video data signals which are transmitted to each of the Access Points and additional layers of FEC data signals are generated and transmitted in different multicast groups by using additional IP addresses or source ports or destination ports. These new multicast groups are dynamically configured within the network so as to allow the transmission of specifically configured FEC signals for specific Access Points within the network and the decision can be made on an Access Point by Access Point basis.

This is beneficial because it reduces the network and wireless link bandwidth utilisation when less FEC is needed and therefore allows other traffic to use the same bandwidth and hence reduces the amount of interference caused to neighbouring Access Points on the same channels as the transmission medium would be utilised less. In addition, or alternatively, in relatively good wireless transmission environments, the video transcoding output data rate can be increased if the bandwidth is not required for other traffic or FEC which results in an improved user experience.

Thus, in comparison to the conventional system, the current invention allows the additional step of selectively splitting the FEC data signals informed by the FEC logging server into multiple, smaller, stackable groups. The system also requires the use of SDN compatible network switches so that the multicast groups sent to each Access point can be reprogrammed at run time based on the FEC logging data received at that time. SDN switches can be used en-route to the Access Points to provide the SDN functionality.

In a further aspect of the invention there is provided a method of providing streams of video data signals to a plurality of access points and at each of which there is the capability to connect at least one device so as to allow said video data to be processed to create a video display, said method comprising the steps of providing an SDN network via which the said video data signals are sent, connecting a plurality of said access points to the said SDN network, generating and sending forward error correction (FEC) data to accompany said video data signals to each of the access points to enhance the quality of the video service from the user devices connected to the access points and wherein the format and/or amount of FEC data transmitted to said access points is defined and configured independently with respect to the FEC data which is determined to be required by the user devices connected to the respective access points.

Specific embodiments of the invention are now described with reference to the accompanying drawings wherein:

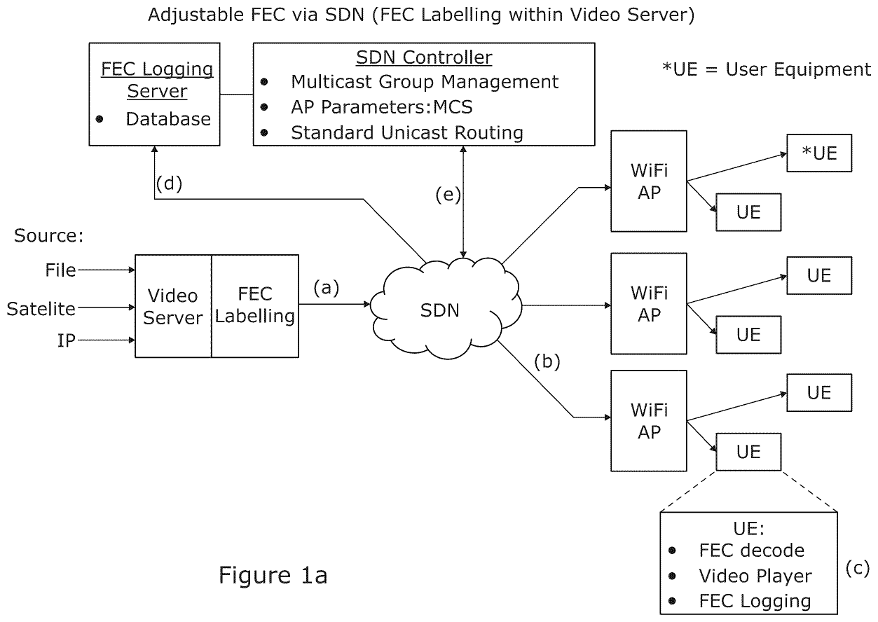

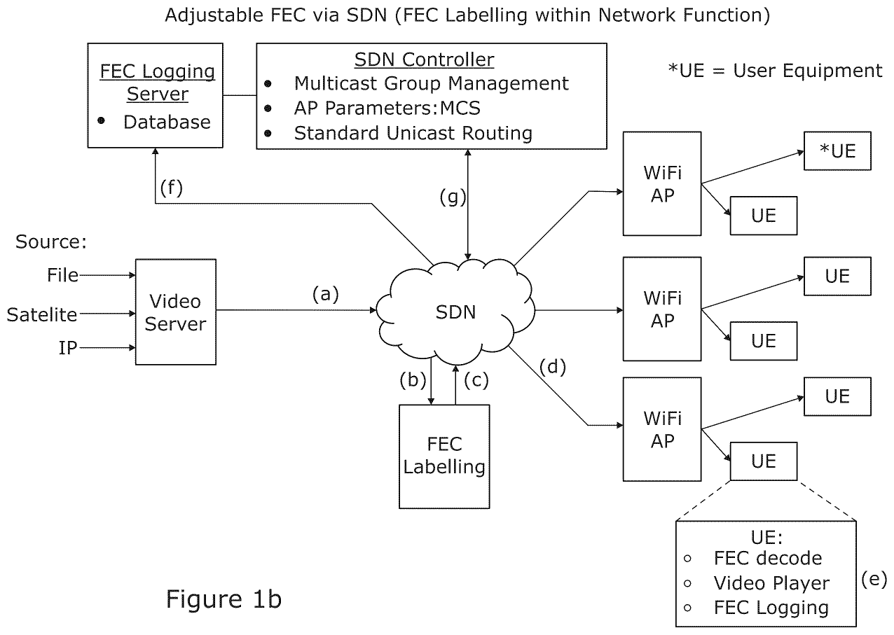

FIG. 1a and b show an example of an SDN enabled Wi-Fi system in accordance with the invention wherein in FIG. 1a the FEC labelling capabilities are included within the Video Server and in FIG. 1b the FEC labelling capabilities are within a Network Function;

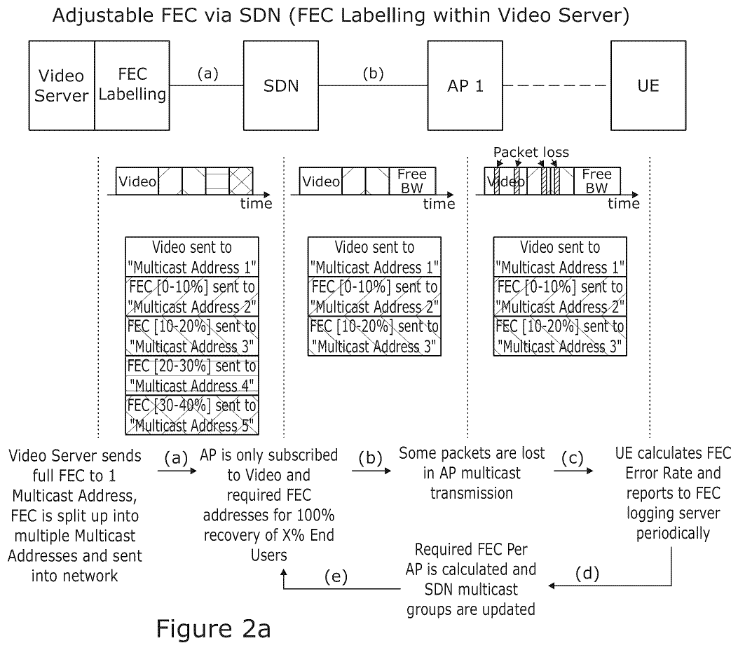

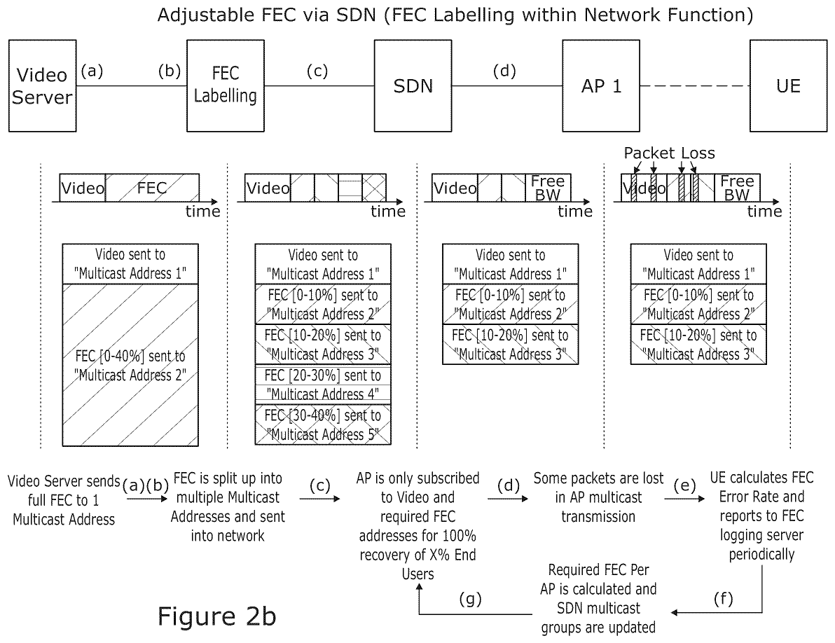

FIG. 2 a and b illustrate an example Video and FEC packet flow from a Video and FEC server via an SDN to the Wi-Fi Access Points, wherein in FIG. 2a the FEC labelling capabilities are included within the Video Server and in FIG. 2b the FEC labelling capabilities are within a Network Function;

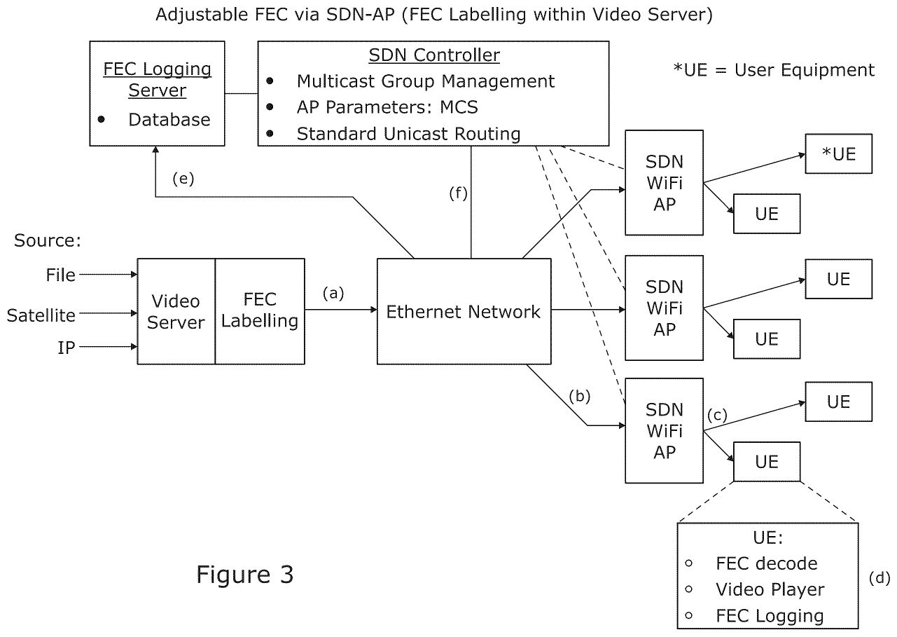

FIG. 3 illustrates an SDN enabled access point architectural overview; and

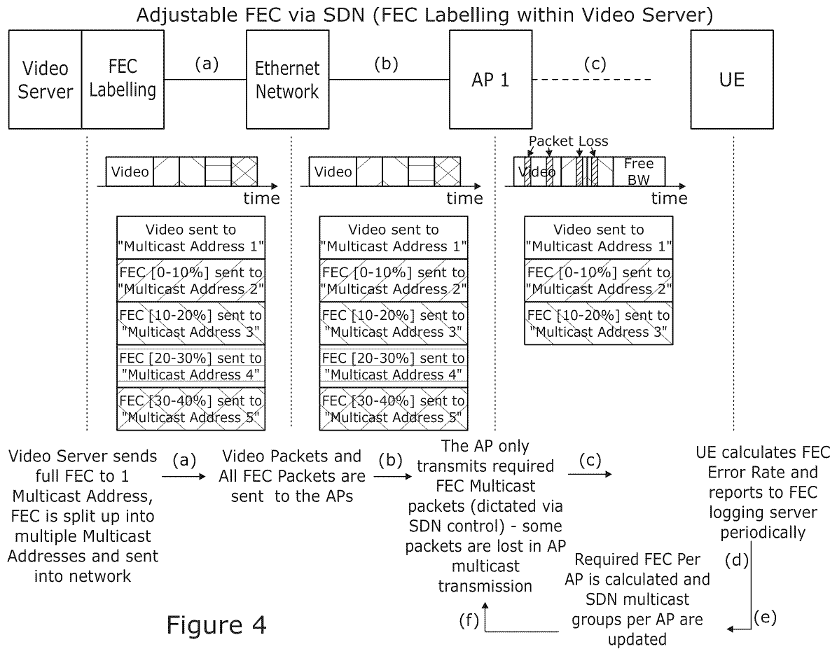

FIG. 4 illustrates an example Video and FEC packet flow and processing steps through an SDN enabled/Access Point network in accordance with one embodiment of the invention.

Referring firstly to FIG. 1a, b and 3, there is provided an example of an SDN enabled Wi-Fi system topology in accordance with one embodiment of the invention.

There is provided data signals receiving apparatus to receive from sources including, but not restricted to, USB file sources, Satellite TV and radio, Terrestrial TV and radio, local file sources, IPTV content, or live video from cameras connected via BNC or USB for example and the data signals are subsequently passed to a processing server which is connected via ethernet connection to an SDN network. The SDN network is, in turn, connected to a series of Access Points, each of which serve a number of user equipment devices.

In FIG. 1a at location (a) the FEC and Video packets transmitted by the integrated Video/FEC processing server enter an SDN network and are forwarded to the Access Points in the network. The FEC packets sent to each Access Point are either forwarded or dropped depending on the amount of FEC required, shown at FIG. 1a location (b). This is determined by the feedback loop established by the FEC logging from the User Equipment shown at FIG. 1a location (c) and to the FEC Logging Server at FIG. 1a location (d) and is enforced by the SDN controller at FIG. 1a location (e).

In FIG. 2a the processing of the packets can be viewed with cross reference to FIG. 1a. At FIG. 2a location (a) the FEC and Video packets transmitted by the integrated Video/FEC processing server enter an SDN network and are forwarded to the Access Points in the network. The FEC packets sent to each Access Point are either forwarded or dropped depending on the amount of FEC required, shown at FIG. 2a location (b). This is determined by the feedback loop established by the FEC logging from the User Equipment shown at FIG. 2a location (c) and to the FEC Logging Server at FIG. 2a location (d) and is enforced by the SDN controller at FIG. 2a location (e).

In FIG. 1b at location (a) the Video Server transmits Video and FEC packets that are all destined for the same multicast group into an SDN network. At FIG. 1b at location (b) the SDN network forwards the Video and FEC packets to a FEC Labelling network function. Within the FEC Labelling function the FEC packets are re-addressed into new multicast groups, thereby allowing granular control of the FEC packets. At FIG. 1b location (c) the Video and relabelled FEC packets are sent into the SDN network. At FIG. 1b location (d) the Video and relabelled FEC packets are sent to the Access Points. The FEC packets sent to each Access Point are either forwarded or dropped depending on the amount of FEC required. This is determined by the feedback loop established by the FEC logging from the User Equipment shown at FIG. 1a location (e) and to the FEC Logging Server at FIG. 1a location (f) and is enforced by the SDN controller at FIG. 1b location (g).

In FIG. 2b the processing of the packets can be viewed with cross reference to FIG. 1b. At FIG. 2b location (a) the Video Server transmits Video and FEC packets that are all destined for the same multicast group into an SDN network. At FIG. 2b at location (b) the SDN network forwards the Video and FEC packets to a FEC Labelling network function. Within the FEC Labelling function the FEC packets are re-addressed into new multicast groups, thereby allowing granular control of the FEC packets. At FIG. 2b location (c) the Video and relabelled FEC packets are sent into the SDN network. At FIG. 2b location (d) the Video and relabelled FEC packets are sent to the Access Points. The FEC packets sent to each Access Point are either forwarded or dropped depending on the amount of FEC required. This is determined by the feedback loop established by the FEC logging from the User Equipment shown at FIG. 2a location (e) and to the FEC Logging Server at FIG. 2a location (f) and is enforced by the SDN controller at FIG. 2b location (g).

In FIG. 3 at location (a) the FEC and Video packets transmitted by the integrated Video/FEC processing server enter an Ethernet (not SDN enabled) network and are forwarded to the SDN-enabled Access Points in the network via normal L2 or L3 multicast routing. At FIG. 3 location (b) all of the Video and FEC packets are forwarded to the SDN-enabled Access Points. At FIG. 3 location (c) the Video packets are forwarded to the User Equipment and a subset of the FEC packets is forwarded to the User Equipment. The subset of FEC multicast groups that are dropped or forwarded is determined by the feedback loop established by the FEC logging from the User Equipment shown at FIG. 3 location (d) and to the FEC Logging Server at FIG. 3 location (e) and is enforced by the SDN controller at FIG. 3 location (f).

In FIG. 4 the processing of the packets can be viewed with cross reference to FIG. 3. In FIG. 4 at location (a) the FEC and Video packets transmitted by the integrated Video/FEC processing server enter an Ethernet (not SDN enabled) network and are forwarded to the SDN-enabled Access Points in the network via normal L2 or L3 multicast routing. At FIG. 4 location (b) all of the Video and FEC packets are forwarded to the SDN-enabled Access Points. At FIG. 4 location (c) the Video packets are forwarded to the User Equipment and a subset of the FEC packets is forwarded to the User Equipment. The subset of FEC multicast groups that are dropped or forwarded is determined by the feedback loop established by the FEC logging from the User Equipment shown at FIG. 4 location (d) and to the FEC Logging Server at FIG. 4 location (e) and is enforced by the SDN controller at FIG. 4 location (f).

User Equipment use a wireless video playback application on their respective devices which allows FEC logging data to be sent back to a database in the cloud or the LAN to allow for further processing. This database is checked regularly by an application that determines the amount of FEC required for each Access Point in the network in order to allow devices located at the respective Access Points to operate to a predetermined quality threshold and sends the results to the SDN controller. The SDN controller then implements these changes across the network and typically this is performed continuously.

The process described can be replicated multiple times in one network allowing multiple data streams to be transmitted in parallel from the Video/FEC server to the User Equipment. When two or more data streams are being transmitted through the network a separate feedback loop and multicast group management is established per data stream allowing the amount of FEC transmitted per data stream per Access Point to be controlled separately without influence from other data streams working in the network.

The processing steps are illustrated in more detail in FIGS. 2 and 4 and illustrate the manner in which the video source sends full FEC to the unicast address along with the video signals. At the VNF multicast FEC splitting facility, the FEC is split into multiple multicast groups and sent into the network. Each Access Point is subscribed to video and the required FEC level for full recovery that the end users need by the SDN and this is transmitted to the Access Points and it will be illustrated that the analysis and provision of different levels of FEC data signals for different Access Points, which for certain Access Points, may be a more limited FEC data requirement, allows the freeing up of bandwidth. Invariably, some packets of data will be lost in the Wi-Fi transmission to the Access Point and the devices at the end user locations for each respective Access Point and so a calculation is performed of the FEC usage and the statistics relating to this, are sent by a feedback loop back to the SDN controller and then the variable required FEC for each Access Point is recalculated based on the device user feedback value from each Access Point so that a reconfigured set of FEC data, with any adaptation which is required can then be transmitted at the next transmission to the respective Access Points and this is then repeated continuously to allow real time adaptation of the FEC data signals which are transmitted to the respective Access Points.

Thus, in one example of use of the current invention if the network has two access points, each with multiple devices served thereby then if the Access Point 1 has relatively good wireless characteristics so that even the worst device from Access Point 1 provides FEC logging data feedback indicating few packet losses, then the SDN may only send the data signals for the video stream and relatively few additional FEC multicast groups to Access Point 1. If Access Point 2 generates from its worst device, FEC logging data which reports more packet losses on the wireless link, Access Point 2 will be subscribed to a greater number of FEC multicast groups, so that the video packet losses can be recovered by the end user devices at that Access Point 2.

1. An SDN data distribution network including apparatus for the receipt of video data signals from one or more remote sources, means for transmission of the received data signals to a plurality of access points on said SDN network and means for continuously generating and sending forward error correction (FEC) data to enhance the quality of the video service provided from one or more user devices connected to said access points and control means to configure the format and/or amount of FEC data transmitted is with reference to each specific access point and with respect to the FEC data determined to be required by the one or more user devices connected to said access point, wherein the configuration of FEC data required to be sent to the respective access points is determined independently for each of said access points and the FEC data transmitted to respective access points is independently controlled and variable with regard to the other of the said access points.

2. (canceled)

3. A network according to claim 1 wherein at least one device at each of the access points transmits data that includes error information to a database which indicates a quality of video service at each of the access points at that instance of time.

4. Apparatus according to claim 3 wherein the error information which is received is processed and one or more indicators are generated to represent the quality of service at the devices at the respective access points and, in response to that analysis, the type and quantity of the FEC data transmitted to each of the access points is controlled and, if necessary, altered.

5. A network according to claim 3 wherein the said control is any or any combination of, to retain the FEC data sent to each of the access points at the same level, to change the FEC data which are sent to all of the access points and/or to selectively change the FEC data which are sent to different access points.

6. A network according to claim 1 wherein any changes in the FEC data transmitted is performed in real time so as to allow any necessary changes to be made as soon as practical after receipt of information indicating that a change is necessary for one or more of the access points.

7. A network according to claim 1 wherein the available bandwidth for transmission of the FEC data is managed in order to ensure the differences in the level of FEC data required by different access points is taken into account and an appropriate level of FEC data is transmitted to each of the respective access points.

8. A network according to claim 1 wherein there is provided a scalable amount of FEC data in the network with respect to the amount of FEC needed to provide the video service via one or more devices at specific access points.

9. A network according to claim 1 wherein there is provided a base layer of data transmission including the video data transmitted to each of the access points and additional layers of FEC data signals are generated and transmitted in different multicast groups by using additional IP addresses, source ports or destination ports.

10. A network according to claim 9 wherein new multicast groups are dynamically configured within the network so as to allow the transmission of specifically configured FEC data for specific access points within the network and configuration of the FEC data on an access point by access point basis.

11. A network according to claim 1 wherein the FEC data is selectively split into multiple stackable groups in response to video error information received from one or more access points.

12. A network according to claim 1 wherein the network includes SDN compatible network switches to allow multicast groups of the data sent to said access points to be reprogrammed.

13. A network according to claim 12 wherein the said SDN switches are located intermediate the source of the FEC data and said access points.

14. A method of providing streams of video data signals to a plurality of access points and at each of which there is the capability to connect at least one device so as to allow said video data to be processed to create a video display, said method comprising the steps of providing an SDN network via which the said video data signals are sent, connecting a plurality of said access points to the said SDN network, continuously generating and sending forward error correction (FEC) data to accompany said video data signals to each of the access points to enhance the quality of the video service from the user devices connected to the access points and the format and/or amount of FEC data transmitted to said access points is defined and configured independently with respect to the FEC data which is determined to be required by the at least one user devices connected to the respective access points, wherein transmitting FEC data to respective access points and said FEC data is independently controlled and variable with regard to the FEC data sent to the other said access points.

15. A method according to claim 14 wherein the said at least one user device at each of the access points transmits data that includes error information to a database which indicates the quality of video service at each of the access points at that instant of time.

16. A method according to claim 15 wherein the error information which is received is processed and one or more indicators generated to represent the quality of service at the particular access point and, in response to that, the type and/or quantity of FEC data transmitted to the respective access points is controlled.
